(19) United States
(12) Patent Application Publication
(10) Pub. No.: US 2006/0226377 A1
(43) Pub. Date: Oct. 12, 2006

(54) Plasma radiation source

(75) Inventors: Guido Hergenhan, Grossloebichau (DE); Kai Gaebel, Jena (DE); Thomas Brauner, Goettingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: XTREME technologies GmbH

(21) Appl. No.: 11/402,356

(22) Filed: Apr. 11, 2006

(30) Foreign Application Priority Data
Apr. 12, 2005 (DE) 10 2005 017 263.6

(51) Int. Cl. G21G 4/00

(52) U.S. Cl. 250/493.1

(57) ABSTRACT

The object of a plasma radiation source is to ensure a more effective protection against debris and, in particular, to counteract secondary sputtering. A target flow that is provided by a target generator by means of a target nozzle and a plasma that is generated by a pulsed excitation beam are enclosed within a vacuum chamber by a gas flow directed transverse to the optical axis.

### CROSS-REFERENCE TO RELATED APPLICATION

This application claims priority of German Application No. 10 2005 017 263.6, filed Apr. 12, 2005, the complete disclosure of which is hereby incorporated by reference.

### BACKGROUND OF THE INVENTION

a) Field of the Invention

The invention is directed to a plasma radiation source containing a target generator with a target nozzle for the metering and orientation of a target flow for plasma generation and a vacuum chamber in which a pulsed excitation beam is directed to the target flow in order to generate a radiation-emitting plasma whose radiation is directed from at least one optical element to a radiation outlet opening in the vacuum chamber and which has a gas inlet and a gas outlet for a gas flow serving as debris protection.

b) Description of the Related Art

Lithography in extreme ultraviolet requires radiation sources with sufficiently intensive radiation and a low debris burden. The latter is important because debris can exert a harmful influence on optical components performing beam-shaping functions for utilization of the radiation. Therefore, suitable steps must be taken to counteract a reduction in the lifetime of the optical components.

On the one hand, the radiation sources can be conceived in such a way through the type of plasma excitation, the design of the plasma environment and the choice of the material composition of the plasma that as little debris as possible is generated; but this often runs counter to optimized conversion efficiency.

On the other hand, active protective steps are known which involve deflection by electric and/or magnetic fields, adsorption on surfaces, e.g., foil traps, and mechanical shutters.

Further, it is known to provide protection against particles by means of a flat, flowing gas layer (EP 0 174 877 B1).

WO 03/026363 A1 attempts to overcome the disadvantage that a sufficient debris suppression can only be achieved with high gas flows by using a supersonic gas jet which is dedicated only to the protection of the collector optics and which extends either perpendicular to the optical axis through the radiation source or is directed to a diffuser from a nozzle arranged on the optical axis. However, this disadvantage is not adequately eliminated. A further drawback consists in that secondary sputtering is not countered.

### OBJECT AND SUMMARY OF THE INVENTION

Therefore, it is the primary object of the invention to ensure a more effective protection against debris.

According to the invention, this object is met in a plasma radiation source of the type mentioned in the beginning in that the target flow and the radiation-emitting plasma are surrounded by a gas flow directed transverse to the optical axis.

The plasma radiation source according to the invention can be further developed in a particularly advantageous manner in that the target nozzle is directed through the center of an annular nozzle which forms the gas inlet and through which the gas flow that is directed transverse to the optical axis and surrounds the target flow and the radiation-emitting plasma is generated.

The annular nozzle is advantageously formed as a Laval ring-jet nozzle which generates, as debris protection, a supersonic gas flow that surrounds the target flow and the radiation-emitting plasma coaxially as a hollow cylinder.

The substantial advantage of the invention consists in that fast particles exiting the plasma are decelerated and thermalized in a surrounding region of the plasma essential for the function of the radiation source as a result of the enclosure of the target flow and, in particular, of the radiation-emitting plasma. As a result, not only are the collimating optics protected against direct damage from the fast particles, but also a release of material within the radiation source resulting from erosion caused by the fast particles moving in all directions can be prevented. Otherwise, vaporized material would precipitate on functional elements inside the radiation source due to condensation and would lead to mirror-dullness of the collimating optics.

In a particular embodiment of the invention, a nozzle arrangement is provided which forms the gas inlet and is distributed around a center, the target nozzle being directed into the nozzle arrangement, and the nozzle arrangement generates partial gas flows which at least partly enclose the target flow and the radiation-emitting plasma by mutual overlapping.

In an advantageous embodiment, the nozzle arrangement can be constructed as a Laval nozzle arrangement which generates the partial gas flows as supersonic gas flows.

By means of the overlapping, directed partial gas flows, a solid angle determined by the arrangement of the partial gas flows can be completely protected from the plasma by limiting the propagation of debris to the extent that harmful effects on the collimating optics and other component parts of the radiation source are prevented. Slightly elliptic jet cross sections which can be made to overlap effectively as round cross sections are especially advantageous.

Based on the steps according to the invention, the absorption of the generated radiation by the gas used for debris reduction can be kept low because the gas flows are in close proximity to the target flow and the plasma so that large portions of the radiation reflected by the collimating optics are directed past the columnar gas flow due to the divergence. In this way, the gas burden is reduced by the invention compared to known technical solutions.

The invention will be described more fully in the following with reference to the schematic drawing.

### BRIEF DESCRIPTION OF THE DRAWINGS

In the drawings:

FIG. 1 shows a vertical section through a plasma radiation source in which a cylindrical gas flow surrounds the target flow and the plasma;

FIG. 2 shows a horizontal section through the plasma radiation source according to FIG. 1; and

FIG. 3 shows a vertical section through a plasma radiation source in which the target flow and the plasma are surrounded by partial gas flows;

FIG. 4 shows a horizontal section through the plasma radiation source with overlapping partial gas flows surrounding the target flow and the plasma.

### DESCRIPTION OF THE PREFERRED EMBODIMENTS

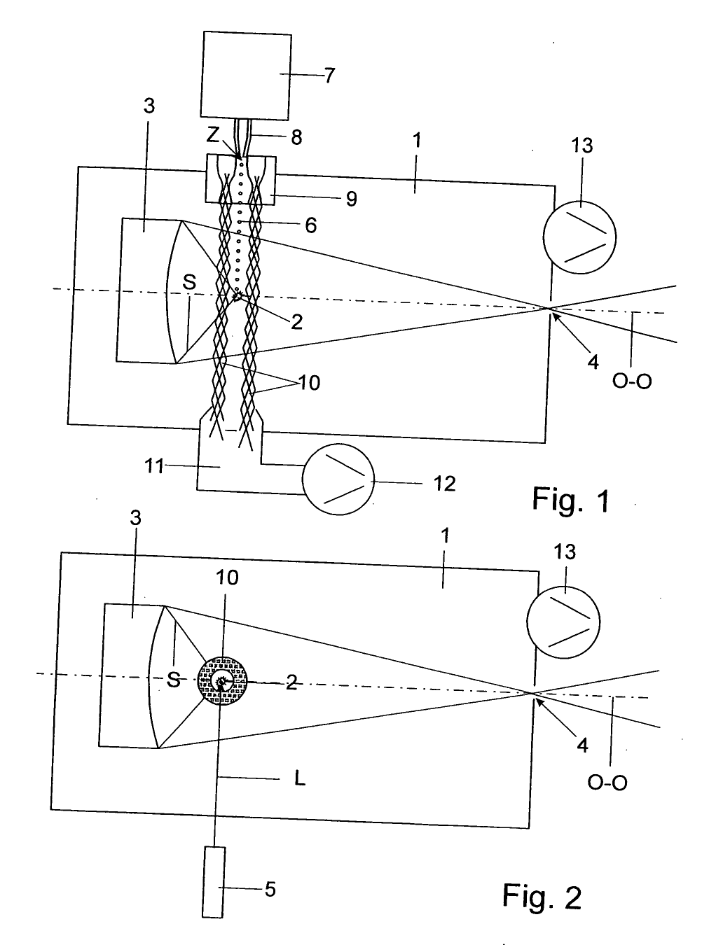

The plasma radiation source shown in FIGS. 1 and 2 contains, in a vacuum chamber 1, a plasma 2 which is induced by laser radiation. The radiation S emitted by the plasma 2 is directed to a radiation outlet opening 4 in the vacuum chamber 1 by means of an optical element which is arranged in the vacuum chamber 1 and constructed as a collector mirror 3. An intermediate focus is generated by imaging the plasma 2 with the collector mirror 3, this intermediate focus being localized in, or in the vicinity of, the radiation outlet opening 4 and serving as an interface to exposure optics in a semiconductor exposure installation for which the plasma radiation source, preferably designed for the EUV wavelength region, is provided.

The laser radiation L generated by a laser 5 is directed preferably perpendicular to a target flow 6 for the generation of plasma as excitation radiation, this target flow 6 advantageously being supplied by a target generator 7 via a target nozzle 8, e.g., as a continuous flow of droplets. Of course, other types of high-energy radiation besides the laser radiation L can also be used as excitation radiation when they are suitable for exciting the plasma 2, e.g., an electron beam.

The target nozzle 8 is directed into the center of an annular nozzle that forms a gas inlet in the vacuum chamber 1 for a gas flow serving as debris protection.

In a preferred construction, a Laval ring-jet nozzle 9 is used as annular nozzle for generating a supersonic gas flow 10 which surrounds the target flow 6 and the plasma 2 coaxially as a hollow cylinder so that, besides the collector mirror 3, other structural component parts of the radiation source that are exposed to the plasma 1 are also protected from erosion.

In particular, the invention ensures protection from secondary sputtering which is caused by the fast particles coming from the plasma 2 in that the fast particles, when impacting on objects in the radiation source, release material that precipitates on the surface of the collector mirror 3 due to condensation on surfaces in the radiation source and, like directly impacting particles, leads to mirror dullness.

The supersonic gas flow 10 is directed to a gas outlet 11 and is guided out of the vacuum chamber 1 through a vacuum pump 12 that is connected to the gas outlet 11 in order to prevent flooding of the vacuum chamber 1 on the one hand and in order to evacuate the vacuum chamber 1 together with another pump device 13 on the other hand.

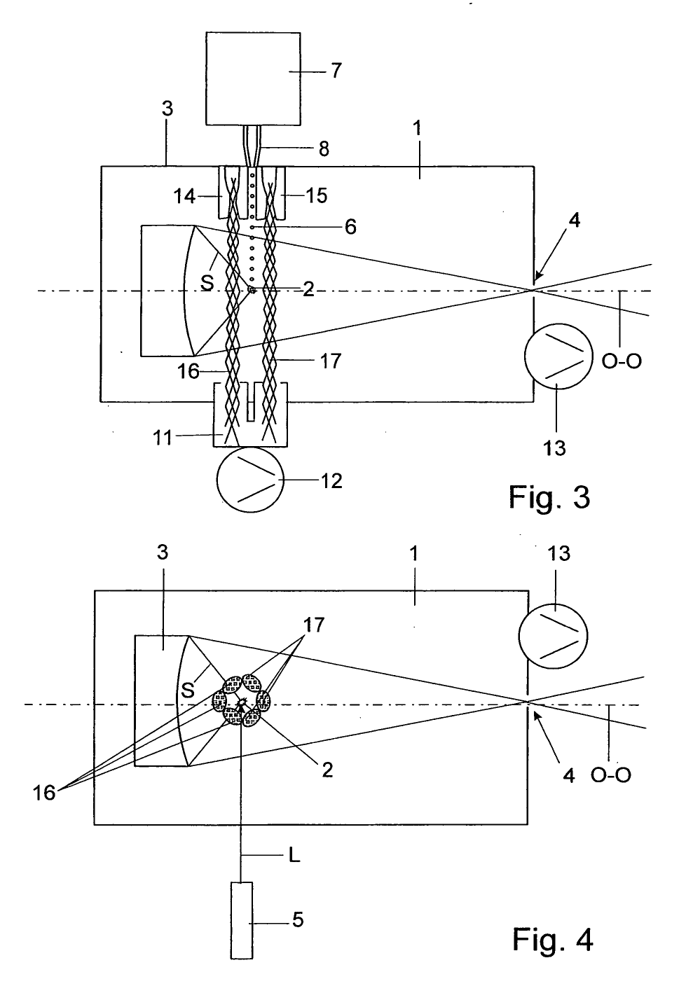

In the embodiment form contained in FIGS. 3 and 4, a nozzle arrangement of individual nozzles 14, 15, preferably Laval nozzles, is arranged around a center Z to which the target nozzle 8 is directed. In contrast to the Laval ring-jet nozzle 9 according to FIGS. 1 and 2, there is no self-contained gas jet, but rather partial gas jets 16, 17 which mutually overlap. Any number of partial gas jets 16, 17 can be arranged that ensures that the target flow 6 and the plasma 2, as in the construction according to FIGS. 1 and 2, are completely surrounded coaxial by a gas envelope along the target flow, or the partial gas jets are limited to only a selected solid angle in which, for example, only the partial gas jets 16 are arranged. As a result of this latter arrangement, the target flow 6 and the plasma 2 are surrounded only partially by a gas envelope in direction of the target flow 6. For the sake of clarity, FIG. 2 shows only two individual nozzles 14, 15 with the associated partial gas flows 16, 17.

While the foregoing description and drawings represent the present invention, it will be obvious to those skilled in the art that various changes may be made therein without departing from the true spirit and scope of the present invention.

What is claimed is:

1. A plasma radiation source comprising:
a target generator with a target nozzle for the metering and orientation of a target flow for plasma generation;
a vacuum chamber in which a pulsed excitation radiation is directed to the target flow in order to generate a radiation-emitting plasma whose radiation is directed from at least one optical element to a radiation outlet opening in the vacuum chamber and which has a gas inlet and a gas outlet for a gas flow serving as debris protection; and
said target flow and radiation-emitting plasma being surrounded by a gas flow directed transverse to the optical axis.

2. The plasma radiation source according to claim 1, wherein the target nozzle is directed through the center of an annular nozzle which forms the gas inlet and through which a gas flow that is directed transverse to the optical axis and surrounds the target flow and the radiation-emitting plasma is generated.

3. The plasma radiation source according to claim 2, wherein the annular nozzle is formed as a Laval ring-jet nozzle which generates, as debris protection, a supersonic gas flow that surrounds the target flow and the radiation-emitting plasma coaxially as a hollow cylinder.

4. The plasma radiation source according to claim 1, wherein a nozzle arrangement is provided which forms the gas inlet and is distributed around a center, the target nozzle being directed into the nozzle arrangement, and in that the nozzle arrangement generates partial gas flows which at least partly enclose the target flow and the radiation-emitting plasma by mutual overlapping.

5. The plasma radiation source according to claim 4, wherein the nozzle arrangement is constructed as a Laval nozzle arrangement which generates the partial gas flows as supersonic gas flows.
